(19) United States
(12) Patent Application Publication
(10) Pub. No.: US 2026/0088318 A1
(43) Pub. Date: Mar. 26, 2026

(54) METHOD FOR OPERATING A FUEL CELL SYSTEM, AND A CONTROL DEVICE

(71) Applicant: Robert Bosch GmbH, Stuttgart (DE)

(72) Inventors: Timo Bosch, Renningen (DE); Tobias Falkenau, Esslingen (DE)

(21) Appl. No.: 18/875,434

(22) PCT Filed: Jun. 22, 2023
(86) PCT No.: PCT/EP2023/066909

§ 371 Date: Dec. 16, 2024

(30) Foreign Application Priority Data
Jun. 22, 2022 (DE) 10 2022 206 259.0

(51) Int. Cl. H01M 8/04223; H01M 8/04119; H01M 8/04228; H01M 8/04303; H01M 8/04537

(52) U.S. Cl. CPC H01M 8/04253; H01M 8/04156; H01M 8/04228; H01M 8/04303; H01M 8/04589; H01M 2250/20

(57) ABSTRACT

The invention relates to a method for operating a fuel cell system, in particular a mobile fuel cell system, comprising a lying fuel cell stack (1) with a face (2) at which media channels (3, 4) for distributing and collecting at least one medium enter and exit, wherein the media channels (3, 4) are dried by applying the at least one medium prior to the fuel cell system being shut down. According to the present invention, prior to the shutdown, the current slope of the fuel cell stack (1) compared to a reference plane (E) that runs perpendicular to earth's gravity vector (v) is detected and the drying duration is determined depending on the current slope of the fuel cell stack (1).

The invention also relates to a control device for a fuel cell system.

### BACKGROUND

The invention relates to a method for operating a fuel cell system, in particular a mobile fuel cell system and a fuel cell vehicle. In addition, the invention relates to a control device configured so as to carry out steps of the method.

Hydrogen-based fuel cells are considered to be the mobility concept of the future, because they only emit water as exhaust gas and enable fast fueling times. In the fuel cells, the oxygen is converted into electrical energy, heat and water together with the hydrogen. To increase the electrical output, a large number of such fuel cells are combined to form a fuel cell stack.

The core of a fuel cell is the membrane electrode assembly. It comprises a membrane coated on both sides with a catalytically active material in order to form electrodes, an anode and a cathode. Hydrogen is supplied to the anode side and air is supplied to the cathode side as an oxygen supplier. The feed in the stack is carried out via media channels that run through the stack and that are also called manifolds. The gases are discharged via further media channels that run through the stack, which are also called collectors. In addition, there are also channels that run through the stack for a coolant of a cooling circuit, by means of which the heat generated during operation is dissipated.

Typically, all media, including the coolant, are fed to and discharged from the same face of the fuel cell stack so that the manifold and collector run parallel to each other as well as perpendicular to the individual fuel cells. In the literature, this type of flow through the fuel cell stack is also referred to as Pi flow. The fuel cell stack can be arranged both standing (fuel cells are orthogonal to the earth's gravity vector) and lying (fuel cells are parallel to the earth's gravity vector).

The lying arrangement of a fuel cell stack presents increased requirements for fuel cell stack drainage during shutdown, because water collects at the respective low point and can lie if the fuel cell stack is at an unfavorable slope—far away from the outlet point of the collector. In this case, drainage cannot be achieved by gravity alone. An unfavorable slope may occur, particularly in mobile fuel cell systems, when the vehicle is parked on an incline, for example. If the vehicle is parked in low ambient temperatures, water collecting at the low point may freeze and cause problems when restarting the system.

To avoid this, it has already been proposed to initiate a drying process prior to shutdown while continuing to supply media to the fuel cell stack. To this end, the cathode and anode-side gas conveying units must continue to be operated, which increases energy consumption.

The present invention relates to the task of reducing energy consumption when drying the media channels of a fuel cell stack in order to save energy and costs.

### SUMMARY

In order to solve this problem, the method according to the disclosure is proposed. A control device for carrying out steps of the method is also specified.

A method for operating a fuel cell system is proposed, in particular a mobile fuel cell system comprising a lying fuel cell stack having a face where media channels for distributing and collecting at least one medium enter and exit. The media channels are dried by applying at least one medium to the fuel cell system before the fuel cell system is turned off. According to the present invention, prior to the shutdown, the current slope of the fuel cell stack is detected compared to a reference plane that is perpendicular to the earth's gravity vector, and the drying duration is determined depending on the current slope of the fuel cell stack.

The proposed method takes into account the current slope of the fuel cell stack during shutdown, which may vary particularly in a mobile fuel cell system. This is because the slope of the fuel cell stack changes depending on whether the vehicle is parked on a level surface or a slope. The media channels can be dried faster or slower, in turn, depending on the slope, so that energy consumption can be reduced by adjusting the drying duration. With a shorter drying time, the application of the respective medium to the media channels can be ended earlier, so that the gas conveying unit required for the application can be switched off earlier.

In further development of the invention, it is proposed that the direction of the current slope of the fuel cell stack is sensed compared to the reference plane. For example, the vehicle may be parked in such a way that gravity assists in the drying of the media channels, so that in this case the drying duration may also be reduced. Conversely, if the vehicle is parked on a slope in the opposite direction of travel, the slope impedes gravity-assisted drying of the media channels. In this respect, the direction of the slope is relevant.

Thus, if the direction of the slope is known, it is possible to differentiate between an unfavorable and a favorable slope of the fuel cell stack compared to the reference plane. For example, the reference plane may run through a low point of a media channel to be dried that is furthest from the media channel face outlet site. If the slope is unfavorable, the outlet point will then be above the reference plane (“+”); if the slope is favorable it will be below (“−”) it. Only in the latter case can water contained in the gas be removed from the media channel using gravity or with the assistance of gravity, so that the drying duration can be reduced.

It follows that the less favorable the current slope of the fuel cell stack is compared to the reference plane, the longer it takes to dry the fuel cell stack. That is to say, no more power is consumed than is absolutely necessary.

To further reduce energy consumption, it is proposed that, if the fuel cell stack slope is favorable compared to the reference plane, drying is carried out solely by way of gravity. That is to say, a gas conveying unit used for the purpose of applying the respective medium to the media channels is turned off.

Furthermore, it is proposed that the current slope of the fuel cell stack compared to the reference plane is sensed during drying and a change in slope is taken into account in determining the drying duration. This is particularly advantageous for mobile fuel cell systems and fuel cell vehicles, because the slope of the fuel cell stack may change continuously until the vehicle is shut down. The change is detected and the drying duration is adjusted accordingly.

When the vehicle is shut down, cathode-side and/or anode-side media channels can be dried. Because water can accumulate on both the cathode and anode sides, advantageously all media channels are dried prior to shutdown. This prevents icing in the media channels.

Further, preferably, the media type of the media channels to be dried is considered when determining the drying duration. This is because the water load may be different depending on the medium, so that the drying duration can be adjusted to it.

In addition, a control device for a fuel cell system is proposed, which is configured to carry out steps of a method according to the invention. For example, the control device may be used to control the drying duration as a function of the current slope of the fuel cell stack. For this purpose, the control unit can receive the measurement data of a slope sensor, with the help of which the current slope of the fuel cell stack can be determined. The method can thus be automated to a great extent.

### BRIEF DESCRIPTION OF THE DRAWINGS

The invention and its advantages are described in more detail below with reference to the accompanying drawings. Shown are:

FIG. 1 a schematic longitudinal section through a standing fuel cell stack,

FIG. 2 a schematic longitudinal section through a lying fuel cell stack,

FIG. 3 a schematic longitudinal section through the fuel cell stack of FIG. 1 at an unfavorable slope,

FIG. 4 a schematic longitudinal section through the fuel cell stack of FIG. 1 at a favorable slope, and

FIG. 5 a diagram graphically illustrating the relationship between the slope of the fuel cell stack and the duration of drying during shutdown.

### DETAILED DESCRIPTION

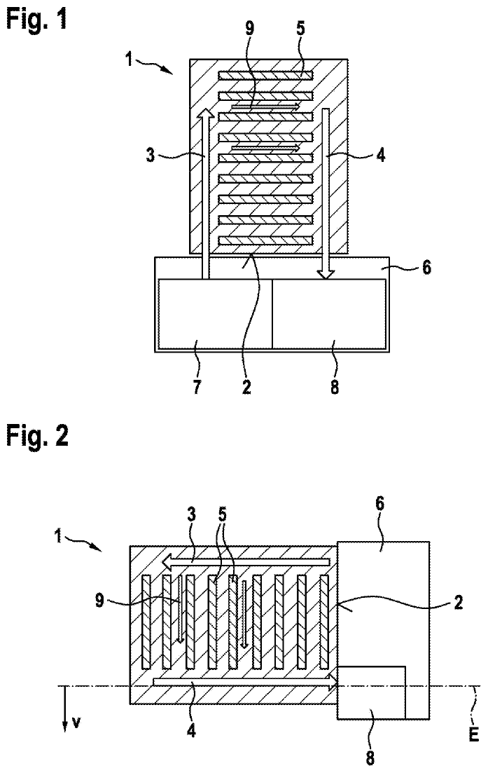

FIG. 1 shows a fuel cell stack 1 for a fuel cell system comprising a plurality of stacked fuel cells 5 supplied with a medium, for example hydrogen, via a media channel 3 (“manifold”) running perpendicular to the fuel cells 5. The medium flows horizontally through the fuel cells 5 along the arrows 9. Medium exiting the fuel cells 5 is discharged from the fuel cell stack 1 via a further media channel 4 (“collector”). The media channels 3, 4 run parallel to one another. The media channel 3 enters a lower face 2 of the fuel cell stack 1. The media channel 4 exits the same face 2 again. An anode subsystem 6 having a gas conveying unit 7 and a water separator 8 is arranged below the fuel cell stack 1. The medium is applied to the media channel 3 with the aid of the gas conveying unit 7. Product water discharged with the medium via the media channel 4 is fed into the water separator 8 with the assistance of gravity.

FIG. 2 shows a lying fuel cell stack 1. In this case, the fuel cells 5 are not arranged on top of one other but rather lying beside one other. The media channels 3, 4 run perpendicular to the fuel cells 5, i.e. horizontally. The anode subsystem 6 is arranged on the side, since the face 2 on which the media channel 3 enters the fuel cell stack 1 and the media channel 4 exits the fuel cell stack 1, also comes to the side. In order to be able to use the gravity to help media flow through the fuel cells 5 (see arrows 9), the media channel 3 serving as a manifold is disposed on the top and the media channel 4 serving as a collector is disposed on the bottom.

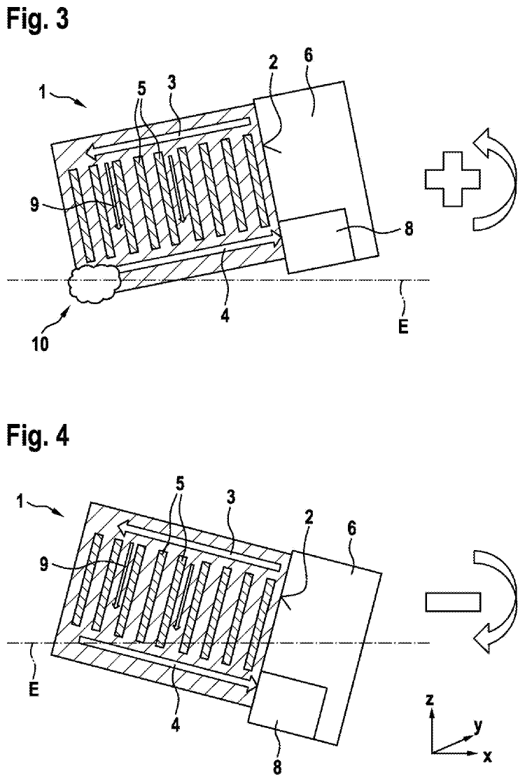

As shown by way of example in FIGS. 3 and 4, in particular in mobile applications, when shut down the fuel cell stack 1 may have a slope compared to a reference plane E that runs perpendicular to an earth gravity vector v (see FIG. 2). In the present case, the height of the reference plane E is selected such that it leads through a lowest point 10 of the media channel 4. If the media channel 4 runs horizontally, the lower edge of the channel forms the lowest point 10.

In the example of FIG. 3, the fuel cell stack 1 is inclined compared to the reference plane E such that the outlet point of the media channel 4 is significantly above the reference plane E on the face 2 (“+”). In this position, water present in the media channel 4 collects at the lowest point 10 due to the force of gravity. The gravity thus impedes the drying of the media channel 4 upon shutdown.

In the example of FIG. 4, the fuel cell stack 1 is inclined compared to the reference plane E such that the outlet point of the media channel 4 is significantly below the reference planes E on the front 2 (“−”). In this position, gravity assists the drying of the media channel 4.

Accordingly, whether the fuel cell stack 1 is unfavorably or favorably inclined when shut down or when drying prior to shutdown. The slope is therefore taken into account in the method according to the invention by determining the drying duration depending on the current slope of the fuel cell stack 1 or by adjusting the drying duration based on the current slope of the fuel cell stack 1.

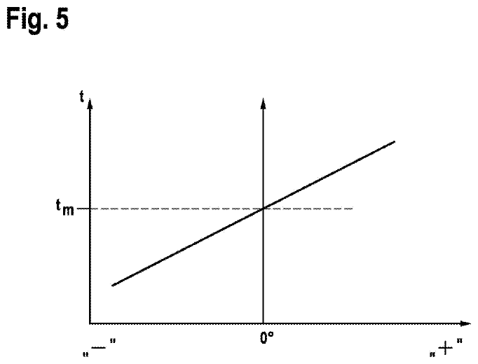

In FIG. 5, the connection between the slope of the fuel cell stack 1 from favorably inclined (“−”) to unfavorably inclined (“+”) and the drying duration t is illustrated by way of an example. Assuming a mean drying duration tm in the event that the fuel cell stack 1 has no slope or a slope of 0°, the more favorable the inclination of the fuel cell stack 1, the shorter the drying time; the less favorable the inclination of the fuel cell stack 1, the longer the drying time.

1. A method of operating a fuel cell system comprising a lying fuel cell stack (1) having a face (2) at which media channels (3, 4) for distributing and collecting at least one medium enter and exit, wherein the media channels (3, 4) are dried by applying the at least one medium prior to the fuel cell system being shutdown,
wherein, prior to the shutdown, a current slope of the fuel cell stack (1) compared to a reference plane (E) that runs perpendicular to earth's gravity vector (v) is sensed and a drying duration is determined as a function of the current slope of the fuel cell stack (1).

2. The method according to claim 1,
wherein a slope direction of the current slope of the fuel cell stack (1) is sensed compared to the reference plane (E).

3. The method according to claim 1,
wherein a distinction is made between an unfavorable and a favorable slope of the fuel cell stack (1) compared to the reference plane (E).

4. The method according to claim 3,
wherein the less favorable the current slope of the fuel cell stack (1) compared to the reference plane (E), the longer the fuel cell stack (1) is dried.

5. The method according to claim 3,
wherein, if the fuel cell stack (1) slopes favorably compared to the reference plane (E), drying is carried out via gravity only.

6. The method according to claim 1,
wherein the current slope of the fuel cell stack (1) compared to the reference plane (E) is sensed during drying and a change in slope is taken into account in determining the drying duration.

7. The method according to claim 1,
wherein cathode-side and/or anode-side media channels (3, 4) are dried upon shutdown.

8. The method according to claim 1,
wherein a type of media for the media channels (3, 4) to be dried is taken into account in determining the drying duration.

9. A control device for a fuel cell system which is configured to carry out steps of a method according to claim 1,

10. The method according to claim 1, wherein the fuel cell system is a mobile fuel cell system.
